(19) United States
(12) Patent Application Publication
(10) Pub. No.: US 2026/0145237 A1
(43) Pub. Date: May 28, 2026

(54) DEVICE FOR SHAPING TEMPERATURE-RESISTANT COMPONENTS BY MEANS OF SELECTIVE LASER MELTING

(71) Applicant: TRUMPF Laser- und Systemtechnik SE, Ditzingen (DE)

(72) Inventors: Niklas ARNOLD, Godlbach (DE); Jan Christian SCHAUER, Stuttgart (DE); Jeroen RISSE, Aachen (DE)

(21) Appl. No.: 19/177,666

(22) Filed: Apr. 14, 2025

Related U.S. Application Data
(63) Continuation of application No. PCT/EP2023/077861, filed on Oct. 9, 2023.

(30) Foreign Application Priority Data
Oct. 18, 2022 (DE) 10 2022 127 242.7

(51) Int. Cl. B22F 10/28; B33Y 30/00

(52) U.S. Cl. CPC B22F 10/28; B33Y 30/00

(57) ABSTRACT

A device for selective laser melting of a near-α Ti alloy includes a coating device for applying layers of the near-α Ti alloy on a substrate panel in a layer arrangement. The layers are arranged on top of one another. The device further includes a laser beam source for providing a laser beam for melting at least parts of the layers, and a heating unit configured to heat an uppermost layer of the layer arrangement in a direction from the substrate panel to the layer arrangement, after application of the uppermost layer and before irradiation of the uppermost layer with the laser beam, to a temperature in a temperature range of 250° C. to 600° C.

### CROSS REFERENCE TO RELATED APPLICATIONS

This application is a continuation of International Application No. PCT/EP2023/077861 (WO 2024/083546A1 ), filed on Oct.9, 2023, and claims benefit to German Patent Application No. DE 10 2022 127 242.7, filed on Oct. 18, 2022. The aforementioned applications are hereby incorporated by reference herein.

### FIELD

Embodiments of the present invention relate to a device for selective laser melting and to a method for selective laser melting.

### BACKGROUND

EP 1 355 760 B1 discloses a device for selective laser melting, in which a heating plate is integrated into a construction platform that can reach heating temperatures of more than 500° C. The heating plate can be used to heat up layers of metallic materials located on the construction platform during the formation of components by means of selective laser melting of the layers. This serves to reduce stresses in the respective component during selective laser melting.

Disadvantageously, the components manufactured with devices known from the prior art often have a comparatively low temperature resistance. Furthermore, the components manufactured in this way continue to exhibit increased residual stresses, which lead to an increased tendency to crack in many materials.

### SUMMARY

Embodiments of the present invention provide a device for selective laser melting of a near-α Ti alloy. The device includes a coating device for applying layers of the near-α Ti alloy on a substrate panel in a layer arrangement. The layers are arranged on top of one another. The device further includes a laser beam source for providing a laser beam for melting at least parts of the layers, and a heating unit configured to heat an uppermost layer of the layer arrangement in a direction from the substrate panel to the layer arrangement, after application of the uppermost layer and before irradiation of the uppermost layer with the laser beam, to a temperature in a temperature range of 250° C. to 600° C.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 schematically shows a device for selective laser melting according to some embodiments.

### DETAILED DESCRIPTION

Embodiments of the invention provide a device for selective laser melting, with which components can be manufactured that are mechanically stable over a wide temperature range. Embodiments of the invention also provide a method for selective laser melting with which such components can be manufactured.

The device according to embodiments of the invention is designed for selective laser melting of a near-α Ti alloy and has the following features:
a substrate panel;
a coating device for applying layers of the near-α Ti alloy on the substrate panel in a layer arrangement, wherein the layers are arranged on top of one another;
at least one layer of the layer arrangement with the near-α Ti alloy;
a laser beam source for melting at least parts of the layers with a laser beam;
a heating unit which is designed to heat an uppermost layer of the layer arrangement in the direction from the substrate panel to the layer arrangement after the application of the uppermost layer and before the irradiation of the uppermost layer with the laser beam to a temperature in a temperature range of 250°c to 600°c.

The at least one layer with the near-α Ti alloy in the layer arrangement ensures that components formed from the layer arrangement by selective laser melting have a comparatively high fracture strength and creep resistance at room temperature as well as at temperatures of several hundred degrees Celsius. In addition, the near-α Ti alloy gives such components a high degree of corrosion resistance.

The device is designed to heat the uppermost layer of the layer arrangement after application before irradiation with the laser beam in order to avoid stresses in the component during the formation of said component, which could, for example, lead to cracks in the component. Avoiding such stresses increases the fracture strength and dimensional stability of the components produced by the method according to embodiments of the invention. In addition, comparatively high growth rates/build rates and large layer thicknesses/layer strengths are possible during selective laser melting. Preferably, construction rates greater than or equal to 20 cm³/h and layer thicknesses greater than or equal to 40μm are possible.

In particular, near-α Ti alloys consist mainly of a hexagonal alpha phase and to a smaller extent of a body-centered cubic beta phase. Preferably, in addition to titanium, near-α Ti alloys contain 1% to 2% of the beta-stabilizing alloying elements vanadium, molybdenum, niobium, tantalum, iron, manganese, chromium, nickel, copper, silicon and/or hydrogen as material. Examples of near-α Ti alloys are Ti-6Al-4V, Ti-6Al-4V-ELI, Ti-6Al-6V-2Sn and/or Ti-6Al-7Nb.

In a preferred embodiment of the device, the heating unit is designed to heat the layer arrangement in a temperature range of 250° C. to 600° C. This reduces stresses between the layers of the layer arrangement in order to increase the mechanical stability of the components formed in the method according to embodiments of the invention.

In an advantageous variant of the device, the heating unit is designed to heat the uppermost layer to a temperature in a temperature range of 300° C. to 500° C., in particular 350° C. to 475° C. Heating the respective uppermost layer of the layer arrangement to a temperature in this temperature range results in particularly low stresses in the respective uppermost layer during selective laser melting. The device according to embodiments of the invention also includes an embodiment which is designed to heat the entire layer arrangement to a temperature in this temperature range.

In a further embodiment of the device, the heating unit is designed in the form of an electric heater of the substrate panel, in particular in the form of a resistance heater. Integration of the heating unit into the substrate panel results in a compact design of the device. An electric heating unit can be quickly and precisely adjusted to a desired heating temperature.

According to an embodiment, the near-α Ti alloy is in the form of Ti6242. Ti6242 is characterized by a relatively good weldability and a comparatively high ductility after preheating in the temperature range according to embodiments of the invention, despite its comparatively simple composition.

A method according to embodiments of the invention for selective laser melting of a near-α Ti alloy has the following steps:
a) coating a substrate panel with a layer arrangement, wherein the layers of the layer arrangement have a near-α Ti alloy as material and are arranged on top of one another and the layer arrangement has an uppermost layer in the direction from the substrate panel to the layer arrangement;
b) heating the uppermost layer of the layer arrangement to a temperature in a temperature range of 250° C. to 600° C.;
c) melting at least parts of the uppermost layer with a laser beam.

Components manufactured using such a method are characterized by high fracture strength and creep resistance even at temperatures of several hundred degrees Celsius. These properties are achieved by the at least one layer which has a near-α Ti alloy as material and by avoiding mechanical stresses in the respective uppermost layer of the layer arrangement before irradiation with the laser beam. Preferably, the entire layer arrangement is heated to a temperature between 250° C. and 600° C. before each irradiation with the laser beam.

In an advantageous embodiment of the method, the uppermost layer of the layer arrangement is heated to a temperature in a temperature range of 300° C. to 500° C., in particular 350° C. to 475° C. This keeps the stresses in the uppermost layer at a particularly low level during selective laser melting. The method according to embodiments of the invention also includes a variant in which the entire layer arrangement is heated to a temperature in this temperature range during the method according to embodiments of the invention.

Similarly, the features mentioned above and the features still to be explained may each be used on their own or together in any desired combinations according to embodiments of the invention. The embodiments shown and described should not be understood as an exhaustive list, but rather are of an exemplary character.

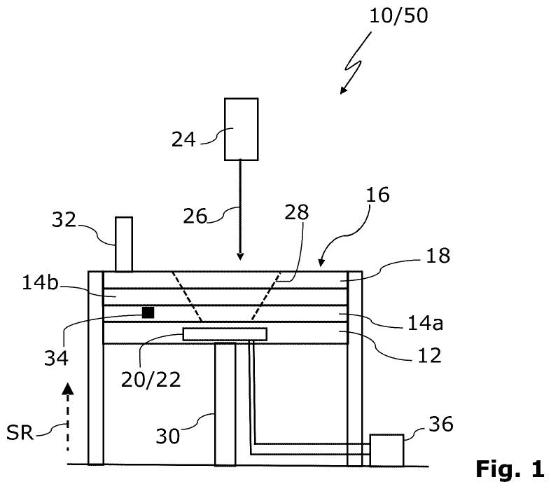

FIG. 1 schematically shows a sectional view of a device 10 for selective laser melting. The device 10 has a substrate panel 12, on which layers 14a, 14b of material powder (not shown) are applied on top of one another in a layer arrangement 16. After application, an uppermost layer 18 of the layer arrangement 16 in the direction SR from the substrate plate 12 to the layer arrangement 16 is heated to a temperature in a temperature range between 250° C. and 600° C. by a heating unit 20. The heating unit 20 is designed as an electric heater 22 which is integrated into the substrate panel 12, thereby enabling a compact design of the device 10 and precise control of the heating temperature by a control system 36 of the electric heater 22.

In addition to the uppermost layer 18, the electric heater 22 also heats the other layers 14a, 14b of the layer arrangement 16, thus reducing stresses between the layers 14a, 14b, 18 of the layer arrangement 16.

In order to at least partially melt the uppermost layer 18 after heating, possibly by fusing it with the other layers 14a, 14b of the layer arrangement 16, the device 10 has a laser beam source 24 from which a laser beam 26 is emitted which irradiates the uppermost layer 18. This forms the layer arrangement 16 into a component 28 (here, for example, a frustoconical shape). By heating the uppermost layer 18 before irradiation, stresses in the component 28 are reduced during forming by the selective laser melting of the uppermost layer 18. After selective laser melting of the respective uppermost layer 18, the substrate plate 12 is lowered by a lifting device 30 of the device 10 in order to apply a new layer of material powder to the layer arrangement 16 by a recoater 32 in a known manner (not shown).

At least one of the layers, here layer 14a by way of example, has a near-α TI alloy 34 as material (symbolized by a black-filled box) in order to give the component 28 a higher dimensional stability at temperatures of several hundred degrees Celsius. In particular, all layers 14a, 14b, 18 of the layer arrangement 16 have the near-α Ti alloy 34 as material. Preferably, at least one of the layers 14a, 14b, 18, in particular all layers 14a, 14b, 18, are formed from a near-α Ti alloy 34.

FIG. 1 also shows a method 50 according to embodiments of the invention, in which the component 28 is manufactured by laser melting of the near-α Ti alloy 34, wherein the uppermost layer 18 is heated to more than 250° C. but less than 600° C. prior to laser melting.

Looking at the figure of the drawing, embodiments of the invention relate to a device 10 for selective laser melting of a near-α Ti alloy 34. The device 10 has a layer arrangement 16 with layers 14a, 14b, 18 applied on top of one another, wherein at least one of the layers 14a comprises the near-α Ti alloy 34. The layer arrangement 16 is arranged on a substrate panel 12 of the device 10. A laser beam source 24 is designed to selectively melt the layers 14a, 14b, 18 with a laser beam 26. A heating unit 20 of the device 10 can introduce thermal energy into an uppermost layer 18 of the layer arrangement 16 in the direction SR from the substrate panel 12 to the layer arrangement 16, in order to heat the uppermost layer 18 to a temperature between 250° C. and 600° C. before the uppermost layer is irradiated with the laser beam 26. The uppermost layer 18 is in particular the layer of the layer arrangement 16 with the greatest distance from the substrate panel 12.

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

### List of Reference Signs

10 Device
12 Substrate panel
14a, 14b Layers of the layer arrangement 16
16 Layer arrangement
18 Uppermost layer
20 Heating unit
22 Electric heater
24 Laser beam source
26 Laser beam
28 Component
30 Lifting device
32 Recoater
34 Near-α Ti alloy
36 Control system of the electric heater
50 Method
SR Direction from the substrate panel to the layer arrangement

1. A device for selective laser melting of a near-α Ti alloy, the device comprising:
a coating device for applying layers of the near-α Ti alloy on a substrate panel in a layer arrangement, wherein the layers are arranged on top of one another;
a laser beam source for providing a laser beam for melting at least parts of the layers;
a heating unit configured to heat an uppermost layer of the layer arrangement in a direction from the substrate panel to the layer arrangement, after application of the uppermost layer and before irradiation of the uppermost layer with the laser beam, to a temperature in a temperature range of 250°C to 600°C.

2. The device according to claim 1, wherein the heating unit is configured to heat the layer arrangement in a temperature range of 250°C to 600°C.

3. The device according to claim 1, wherein the heating unit is configured to heat the uppermost layer to the temperature in a temperature range of 300°C to 500°C.

4. The device according to claim 1, wherein the heating unit is configured to heat the uppermost layer to the temperature in a temperature range of 350°C to 475°C.

5. The device according to claim 1, wherein the heating unit is configured in as an electric heater of the substrate panel.

6. The device according to claim 1, wherein the near-α Ti alloy is Ti6242.

7. A method for selective laser melting of a near-α Ti alloy, the method comprising:
coating a substrate panel with a layer arrangement, wherein the layer arrangement has layers of the near-α Ti alloy arranged on top of one another, and the layer arrangement has an uppermost layer in a direction from the substrate panel to the layer arrangement;
heating the uppermost layer of the layer arrangement to a temperature in a temperature range of 250°C to 600°C; and
melting at least parts of the uppermost layer with a laser beam.

8. The method according to claim 7, wherein the uppermost layer of the layer arrangement is heated to the temperature in a temperature range of 300°C to 500°C.

9. The method according to claim 7, wherein the uppermost layer of the layer arrangement is heated to the temperature in a temperature range of 350°C to 475°C.
